(19) United States
(12) Patent Application Publication
(10) Pub. No.: US 2011/0082773 A1
(43) Pub. Date: Apr. 7, 2011

(54) SYSTEM AND METHOD FOR ORDERING GOODS OR SERVICES USING BLU-RAY® DISC PLAYBACK

(75) Inventor: Charles Potter, Valencia, CA (US)

(73) Assignees: SONY CORPORATION, Tokyo (JP); SONY PICTURES ENTERTAINMENT INC., Culver City, CA (US)

(21) Appl. No.: 12/896,301

(22) Filed: Oct. 1, 2010

Related U.S. Application Data
(60) Provisional application No. 61/248,382, filed on Oct. 2, 2009.

(51) Int. Cl. G06Q 30/00; G06F 3/048; G06F 15/16

(52) U.S. Cl. 705/27.1; 715/810; 709/219

(57) ABSTRACT

Systems and methods are provided to implement a technique for requesting goods or services using an item of content or media. In one implementation, a system provides a mechanism to place food service orders over or using BDs. The food menu is presented to the user using BD Java graphics. After the user selects the food and destination, an order is placed within a network server which relays the request to a food service fulfillment vendor. The order can be coupled with the AACS DeviceAttribute for storing user preferences. An additional function is to have the order coupled with MediaAttribute to, e.g., offer food service as a loyalty program. This allows for title-specific promotions and may be used to determine the food service fulfillment vendors.

### CROSS-REFERENCE TO RELATED APPLICATIONS

This application claims benefit of priority of U.S. Provisional Patent Application Ser. No. 61/248,382, filed Oct. 2, 2009, entitled “FOOD SERVICE ORDER USING BLU-RAY DISCS®”, owned by the assignee of the present invention and incorporated herein by reference in its entirety.

### BACKGROUND

Video content has a long history of being enjoyed in a passive setting. Advanced video media, such as Blu-ray® discs (“BD”), provide a more interactive setting for user enjoyment. For example, users may employ BDs to access specific features on the Internet using the BD-Live® system. Users may also play games or access other interactive content. Interactive systems can enhance the user experience and provide new ways for users to enjoy content.

### SUMMARY

The systems and methods disclosed provide for ordering goods or services, e.g., food, from a media-centric view. One example is using BDs. The software for setting up the food order can be built into the disc through software included on the disc using BD Java. By taking advantage of the information available through the BD format, the ordering and fulfillment can be more targeted and customized.

In one food-based example, if the BD is a movie disc and the movie is a children's movie, the food service can be targeted at food appropriate for or more popular with children. For example, cheese pizza may be more popular than beer. Similarly, the type of merchant and advertising impact of the service may vary depending on the content. In one implementation, the disc could include multiple options for service and the food ordering software could attempt to derive a preference profile from other information available on the media player. For example, if the media player has a hard drive, that hard drive could contain information indicating other movie or television items that have been played recently or are in a library. That content information could be used to estimate a consumer profile and then drive the selection of food service or proposed menu. Similarly, the system could access online or home network resources instead of or in addition to the local information to assist with the profile or recommendations.

By leveraging the functionality of the disc format, e.g., BD, the goods or services ordering application can become more powerful and targeted than a generic web browser application. As a result, a consumer will have a better experience and more happily engage in commercial transactions.

In more detail, the systems and methods are provided to implement a technique for requesting goods or services using an item of content or media. In one implementation, a system provides a mechanism to place food service orders over or using BDs. The food menu is presented to the user using BD Java graphics. After the user selects the food and destination, an order is placed within a network server which relays the request to a food service fulfillment vendor. The order can be coupled with the AACS DeviceAttribute for storing user preferences. An additional function is to have the order coupled with MediaAttribute to offer food service as a loyalty program. This allows for title-specific promotions and may be used to determine the food service fulfillment vendors.

Additional variations are also possible. In one example, the ordering service may be for items other than food, e.g., music downloads, home repair, taxi, and the like. Similarly, other types of content media can be used, such as television, music, or games. In another example, the ordering services are affiliated with or replaced by social networking services or sites. Accordingly, the technology is not limited to the specific examples of implementations discussed.

In one aspect, the invention is directed to a method of providing an ordering functionality using a non-transitory computer-readable medium in a media player, the non-transitory computer-readable medium for causing the media player to perform the following steps: calculating and displaying a menu of choices, the menu pertaining to goods or services available to a user; receiving a selection from a user from the menu of choices; and sending the selection to a fulfillment vendor to provide the selected goods or services to the user.

Implementations of the invention may include one or more of the following.

At least a portion of a set of instructions corresponding to the calculating and displaying, receiving, or sending steps may be located on the computer-readable medium or on the media player. At least a portion of a set of data employed in the calculating or sending steps may be located in a storage in the media player. The portion of data employed in the calculating or sending steps may be located in a user profile on the media player, in a set of user preferences on the media player, in a user history of content consumption on the media player, or in a user ordering history on the media player. At least a portion of a set of data employed in the calculating or sending steps may be located on the computer-readable medium. The method may further include downloading at least a portion of a set of data employed in the calculating or sending steps from an online resource, wherein the downloading is caused by a call to the online resource caused by the computer-readable medium. The method may further include downloading at least a portion of a set of instructions corresponding to the calculating, receiving, or sending steps from an online resource, wherein the downloading is caused by a call to the online resource caused by the computer-readable medium. The call to the online resource may be made through the BD-Live® system. The method may further include a step of receiving payment information from the user for the selected good or service. The menu of choices may be at least partially based on a content item on the computer-readable medium. The portion of data employed in the calculating or sending steps may be chosen from at least two data selected from the group consisting of: a user profile on the media player, a user history of content consumption on the media player, a user ordering history on the media player, data downloaded from a network based on a call caused by the computer-readable medium, or a content item on the computer-readable medium. The sending may include sending the selection to a network server. If the goods are digital goods or services, the method may further include downloading the digital goods or services corresponding to the selection from the fulfillment vendor to the user. The computer-readable medium may be a Blu-ray® disc and the media player is a Blu-ray® player. The method may further include coupling the order with AACS DeviceAttribute to store user preferences or with MediaAttribute, and/or using the attribute to determine the fulfillment vendor.

In another aspect, the invention is directed to a computer-readable medium, comprising instructions for causing a computing system to perform the above method.

In another aspect, the invention is directed to a method of providing an ordering functionality using a Blu-ray® title and a Blu-ray® player, the Blu-ray® title for causing the Blu-ray® player to perform the following steps: transferring a Blu-ray® title from a first online resource to a Blu-ray® player; running the Blu-ray® title; upon the running, calling a second online resource for retrieval of a menu of choices, the menu pertaining to goods or services available to a user; receiving a selection from a user from the menu of choices; and sending the selection to a fulfillment vendor to provide the selected goods or services to the user.

In another aspect, the invention is directed to a computer-readable medium, comprising instructions for causing a computing system to perform the above method.

In another aspect, the invention is directed to a method of providing an ordering functionality using a Blu-ray® disc in a Blu-ray® player, the Blu-ray® disc for causing the Blu-ray® player to perform the following steps: displaying a menu of choices using BD-Java, the menu pertaining to delivery food items available to a user, the menu of choices created using at least information stored on the Blu-ray® player and information retrieved from the BD-Live® network; receiving a selection from a user from the menu of choices; and sending the selection to a fulfillment vendor to provide the selected food items to the user.

In another aspect, the invention is directed to a computer-readable medium, comprising instructions for causing a computing system to perform the above method.

In another aspect, the invention is directed to a computing system, including: memory bearing computer-readable instructions capable of instantiating a user interface for ordering from a menu of choices; memory bearing computer-readable instructions capable of forming the menu of choices based on data on preferences, profile, historical content consumption, or historical ordering choices; and memory bearing computer-readable instructions capable of calling an online resource for additional data on which to based formation of the menu of choices.

In another aspect, the invention is directed to a computing system, including: an ordering module for creating a menu of choices based on content data on a computer-readable medium, user data on a media player, or online data; a receiving module for receiving a user selection from the menu of choices; and a fulfillment module for sending information about the selection to a vendor for fulfillment of the order.

Advantages may include one or more of the following. The goods or services may be ordered using software provided with entertainment media. Goods or services may be recommended, or menus may be constructed using, content on the media, preference or profile information, information stored on a local or home network, data from an online resource, or a combination of these.

### BRIEF DESCRIPTION OF THE DRAWINGS

FIG. 1 is a schematic diagram of an implementation of a system of the invention;

FIG. 2 is a flowchart illustrating a first implementation of a method of the invention showing steps performed by a receiver of a client request;

FIG. 3 is a data flow diagram illustrating data that informs menu content;

FIGS. 4(A) and 4(B) are data flow diagrams illustrating the sources of information for (A) data and (B) applications.

FIG. 5 is a flowchart illustrating a second implementation of a method of the invention showing steps performed in creating a computer-readable medium implementing the invention;

FIG. 6 is a flowchart illustrating a third implementation of a method of the invention showing steps performed in creating a display of options using the data flows of FIGS. 3 and 4;

FIG. 7 is a flowchart illustrating a fourth implementation of a method of the invention, this implementation where the content and menu having been retrieved from online resources;

FIG. 8 illustrates a first exemplary structure of a computing device that may be employed to implement one or more of the features described herein;

FIG. 9 illustrates a second exemplary structure of a computing device that may be employed to implement one or more of the features described herein; and

FIG. 10 illustrates a third exemplary structure of a computing device that may be employed to implement one or more of the features described herein.

Like reference numerals indicate like elements in the drawings. Elements are not drawn to scale unless otherwise indicated.

### DETAILED DESCRIPTION

In the disclosed systems and methods, computer-readable media such as BDs are employed to allow users to conveniently order goods and services using only their media player. Through the interface of the system the user can select these goods and services and have the same delivered physically or electronically. The systems and methods will be discussed in the context of BDs and food ordering; however, one of ordinary skill in the art will recognize that other non-transitory computer-readable media may be used and that other goods and services may be ordered.

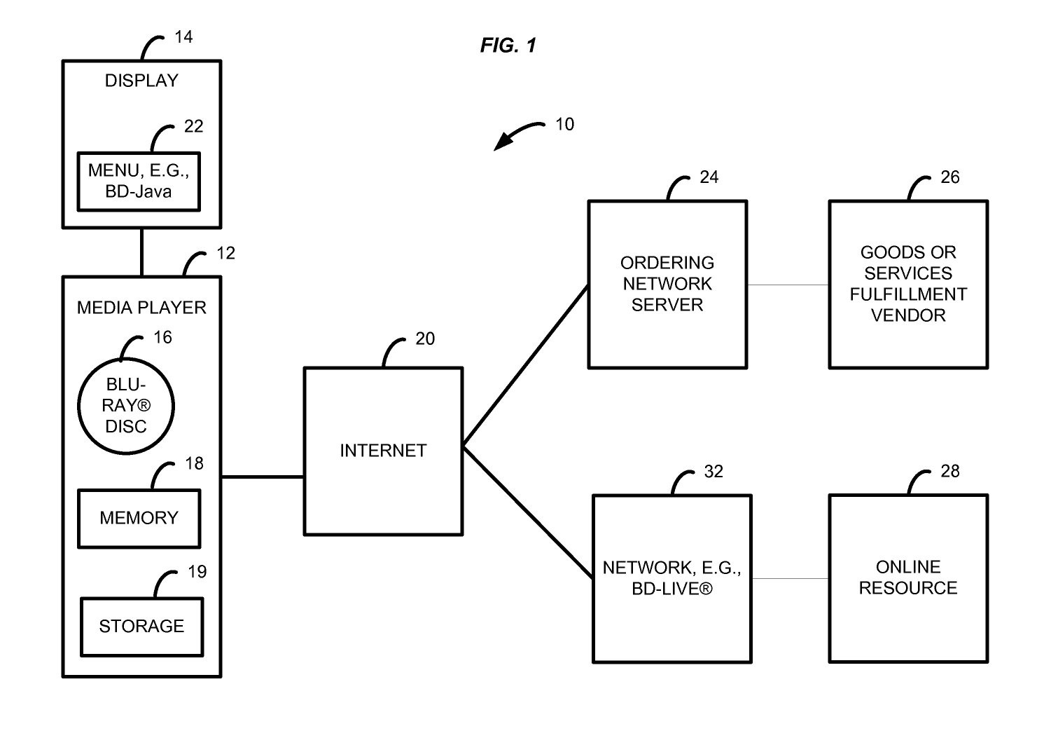

Referring to FIG. 1, a system 10 is shown that may implement the invention. A media player 12 with a display 14 may receive a computer-readable medium such as a BD 16. The media player 12 may also accept content items by downloading the same, and in this case they may be stored in a storage 18. When operated, various data and applications are stored in one or more memories 18. The display 14 is employed to display a menu 22 of choices or options. The menu may be implemented in, e.g., BD-Java.

One appropriate media player may be a Blu-ray® player, including the PlayStation 3® game console available from Sony Computer Entertainment America Inc., of Foster City, Calif. It will be understood that other media players may also be employed, including various computing systems, for BDs or other computer-readable media.

The player 12 communicates with other network components over the Internet 20 although in some implementations a local area network may be employed for this purpose, and such local area networks may be, e.g., wireless or wired. What is generally required is a network by which the player 12 can communicate with a goods or services fulfillment vendor 26. The fulfillment vendor 26 operates such that the same acts upon receipt of a selection by the player 12. The fulfillment vendor 26 may also have a website presence and/or a “bricks and mortar” presence. For example, the vendor 26 may be a food provider, such as a pizza restaurant, that may deliver food to the user prior to the same watching a movie on the BD 16.

An intermediary may be placed between the player 12 and the vendor 26, such as an ordering network server 24. The ordering network server 24 may act as a clearinghouse, and may be operated by the fulfillment vendor 26 or by a third party.

Also shown in FIG. 1 is another network 32, e.g., the BD-Live® network, and the same generally accesses other network components, such as an online resource 28. In some implementations, the ordering network server 24 can be a server on the BD-Live® network. Networks such as BD-Live® can be accessed to obtain stored online information about user preferences, profiles, content consumption history, ordering history, as will be described below. In the case of the BD-Live® network, access is generally gained by the user entering a user identification and password on an on-screen or separate keyboard. In this way, the user can employ the BD-Live® network for ordering and the same can conversely be employed to obtain user information in order to enrich the user experience.

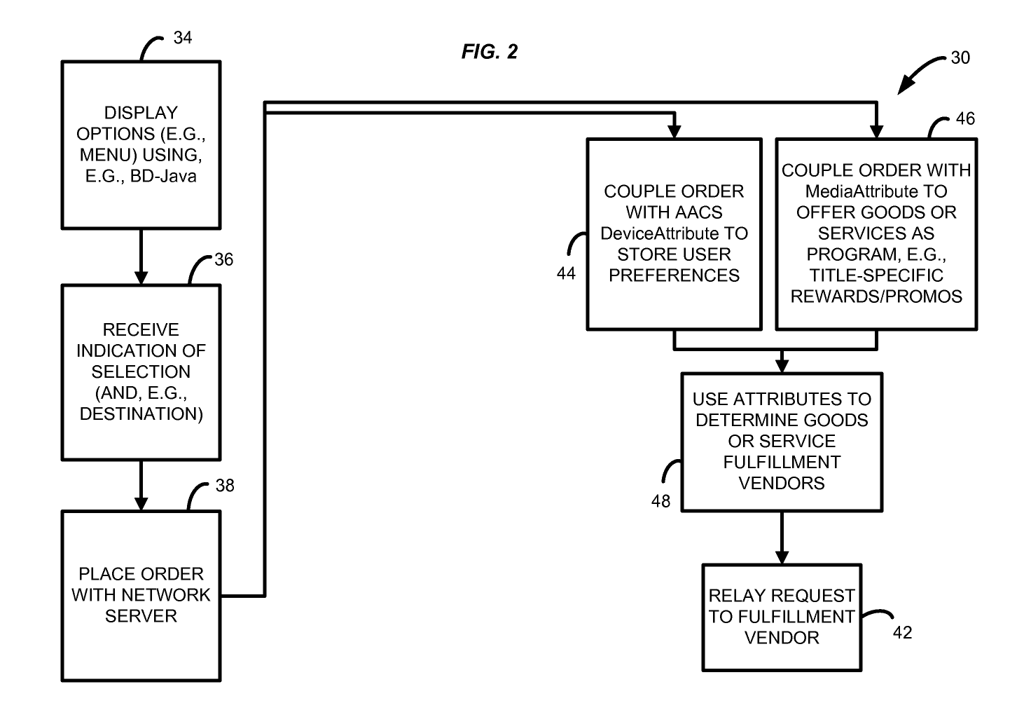

Referring to FIG. 2, a flow chart 30 is shown that illustrates a first implementation of a method of the invention. The method starts with a display of options (step 34). The display of options will typically be a displayed menu, and the same may be displayed using the BD-Java capability. While most displayed options will include several choices, it should be noted that in some cases the display of options will simply be a single option, and the user choice is then to select “yes” to accept the option or “no” to reject the option.

The next step is to receive an indication of the user selection (step 36). The selection is made from the displayed menu of choices. Where a physical delivery is required, such as for the above noted pizza delivery, a destination will also be received from the user if not already provided through a profile or preferences. The order is then placed with a network server (step 38).

The order may be coupled with the AACS DeviceAttribute in BD-Java in order to allow the storage of user preferences (step 44) as these preferences become part of the stored memory of the player. Similarly, the order may be coupled with MediaAttribute in order to offer goods or services as a program, e.g., as a title-specific reward or promotion (step 46). For example, a movie about a pizza restaurant may include specific menu options regarding pizza or Italian food. These attributes may be employed to determine the goods or service fulfillment vendors (step 48). Moreover, these attributes may provide information on prior fulfillment vendors that the user employed and preferred. As a last step, the order is relayed to the fulfillment vendor (step 42).

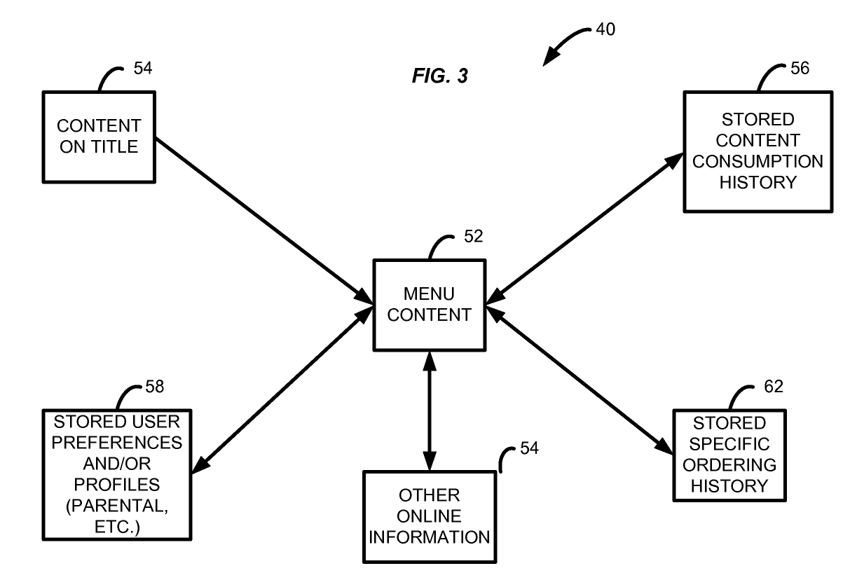

Referring to FIG. 3, a data flow diagram 40 is illustrated showing sets of data that informs menu content 52. For example, content on the title 54 may inform menu content 52. As noted above, for content about or taking place in a particular country, food options may be offered from that country's cuisine. Family or children's titles may incorporate more family-friendly choices for food. Many variations will be seen given this teaching. Another data set that may inform menu content 52 are stored user preferences or profiles 58. Such preferences or profiles 58 may include information about the age and gender of users, as well as parental controls on menu content. Another data set that may inform menu content 52 is a stored content consumption history 56, which includes previous titles or other content viewed by the user. For example, if a user often enjoys movies in which Italian culture plays a role, menu choices may be slanted towards Italian cuisine. Yet another data set that may inform menu content 52 is the user's storage specific ordering history 62. For example, if a user always orders Italian food, again the menu choices may be slanted towards Italian cuisine. For all of these aspects, certain implementations may include both an adult menu and a children's menu. Online resources may be called to obtain other information 59 in certain implementations.

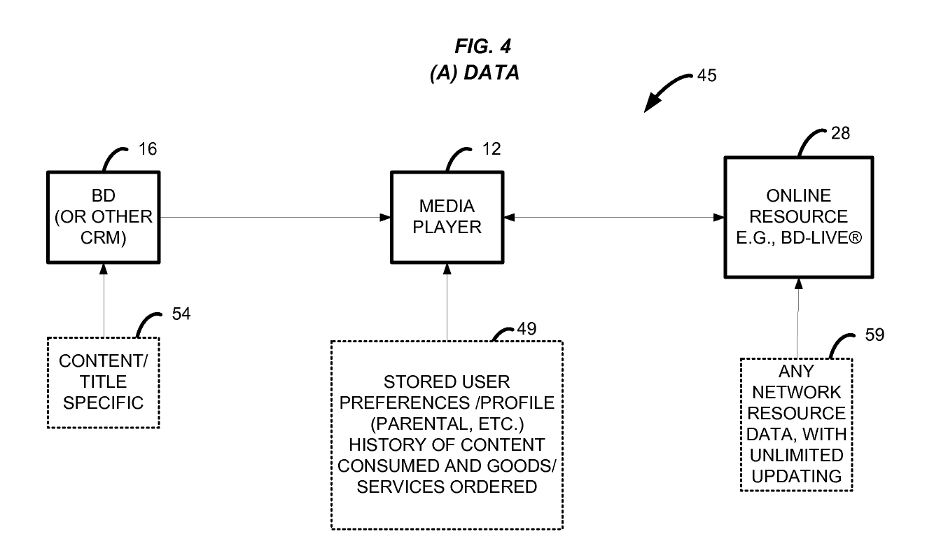

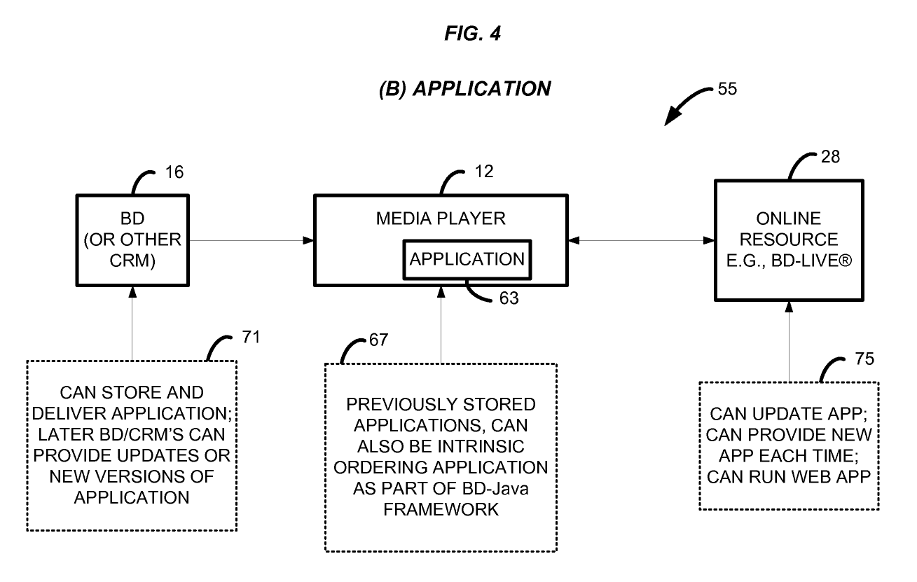

FIGS. 4(A) and 4(B) are more detailed data flow diagrams illustrating the sources of information for (A) data and (B) applications. Referring to FIG. 4(A), a data flow diagram 45 is illustrated showing sources of data on which menu options may be based. The media player 12 receives data 49 from the sources of data illustrated in FIG. 3, including stored user information and a history of content consumed and goods and services ordered. A BD 51 contains metadata 54 appropriate to its content. An online resource 28, e.g., through the BD-Live® network, can receive data 59 from any network source, and can transfer this data to the media player 12. A benefit of the online resource 28 is that the same can continually update the media player 12 to provide updated menu choices even for the same BD. For example, if a sequel movie launches, a new menu choice may be added appropriate to the sequel, even if the predecessor title has been loaded in the media player. In the same way, a promotion may be offered based on the sequel if the predecessor title has been loaded.

Referring to FIG. 4(B), a data flow diagram 55 is illustrated showing sources of data from which the ordering application may be constructed. The media player 12 may have stored an ordering application 63, e.g., in storage 19 (FIG. 1). The source 67 of the application 63 may be previously stored applications, such as may have been loaded by a previous BD or an intrinsic ordering application provided as part of a BD-Java framework. The BD 51 can also provide data 71 corresponding to an ordering application. For example, a BD can itself store an ordering application, and can transfer the same to the media player 12 when inserted. Later-manufactured BDs can provide updates to this application when inserted, or can provide entirely new versions of the ordering application. In the same way as in FIG. 4(A), the online resource 28, e.g., through the BD-Live® network, can receive data 75 about applications or updates from any network source, and can transfer this data to the media player 12 when connected. In the same way as with the data on which the menu is based, a benefit of the online resource data 57 is that the same can continually update the media player 12 to provide updated menu applications even for the same BD. For example, if a sequel movie launches, a new menu skin may appear appropriate to the sequel, even if the predecessor title has been loaded in the media player.

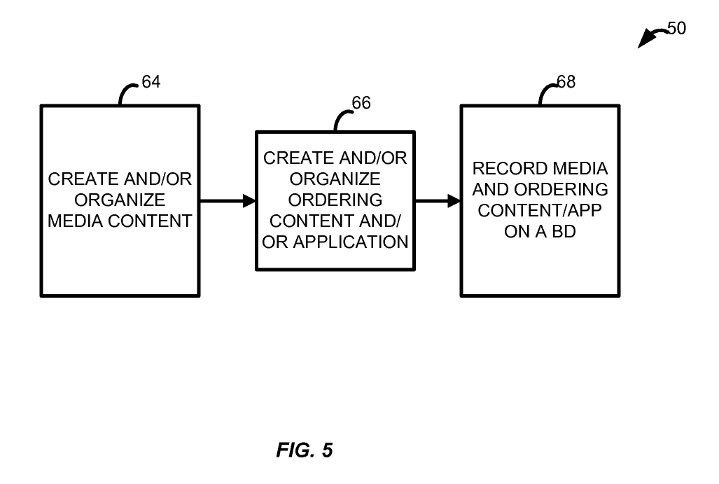

FIG. 5 is a flowchart 50 illustrating a second implementation of a method of the invention showing steps performed in creating a BD implementing the invention. A first step in the flowchart 50 is to create and/or organize media content (step 64). This includes the basic content present on the computer-readable medium, such as a BD as well as titles, previews, supplemental content, and the like. A next step is to create and/or organize ordering content and/or the ordering application (step 66). For example, for an Italian-themed movie, certain menu choices may be present on the computer-readable medium as metadata and used in combination with information about local fulfillment vendors to cause the display of menu choices appropriate to Italian cuisine. In the same way, the latest version of the ordering application can be created for the BD in BD-Java. In some implementations, no such ordering content or application need be present on the manufactured BD. If the firmware or software on the media player is configured appropriately, the content metadata already on the BD may be used to call an online resource for menu options using any or all of the sources of data disclosed above. A last step is to record the media, and any ordering content or application, onto the BD (step 68).

Variations of the above will be seen. For example, the media content is generally a Blu-ray® title but may also be any BD-Java application. Moreover, the step of recording onto a computer-readable medium may include creating a disc, a disc image, a flash drive, or any other such non-transitory computer-readable medium.

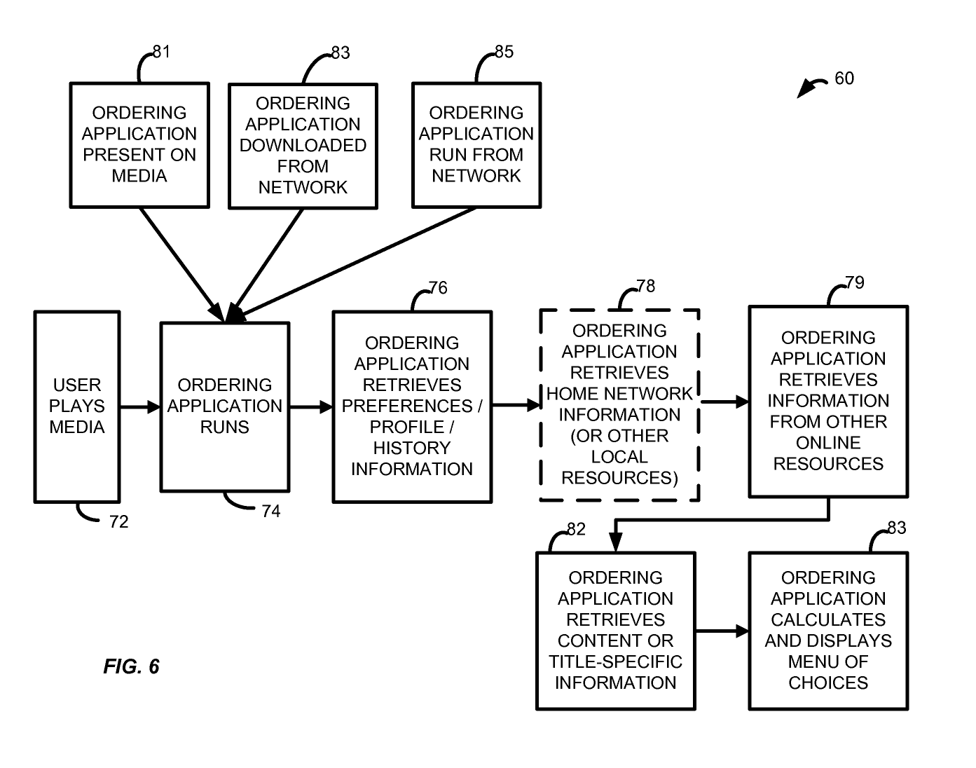

FIG. 6 is a flowchart 60 illustrating a third implementation of a method of the invention showing steps performed in creating a menu of choices using the data flows of FIGS. 3 and 4. A first step is that a user plays the media (step 72). A next step is that the ordering application runs (step 74). This step may occur in a number of ways. For example, the ordering application may be present on the media (step 81). Alternatively, the ordering application may be downloaded from a network (step 83). In another variation, the ordering application may be run from the network (step 85), e.g., as a web application. It is noted in this connection that while this description contemplates applications being present or downloaded, the scope encompasses situations in which an application is partially present and partially downloaded, and other such variations.

A next step is that the ordering application retrieves preferences, profile, or history information (step 76) as described above. A next step is that the ordering application receives information from a home network or other local resource (step 78). This step, which is optional, may include the retrieval of information from other accessible networks, such as game console networks, that may indicate, e.g., whether other family members are home for which an order may be made, or other information on which a menu may be based. A next step is that the ordering application retrieves information from other online resources (step 79). A next step is that the ordering application retrieves content or title-specific information (step 82). As noted above, the menu choices may be based on the content on the BD. Finally, the ordering application uses all of the retrieved data, or a subset of the same, to calculate and display the menu of choices (step 83).

Variations of the above method will be apparent given this teaching. For example, not all of the steps described need be included in any given implementation, and their order may vary.

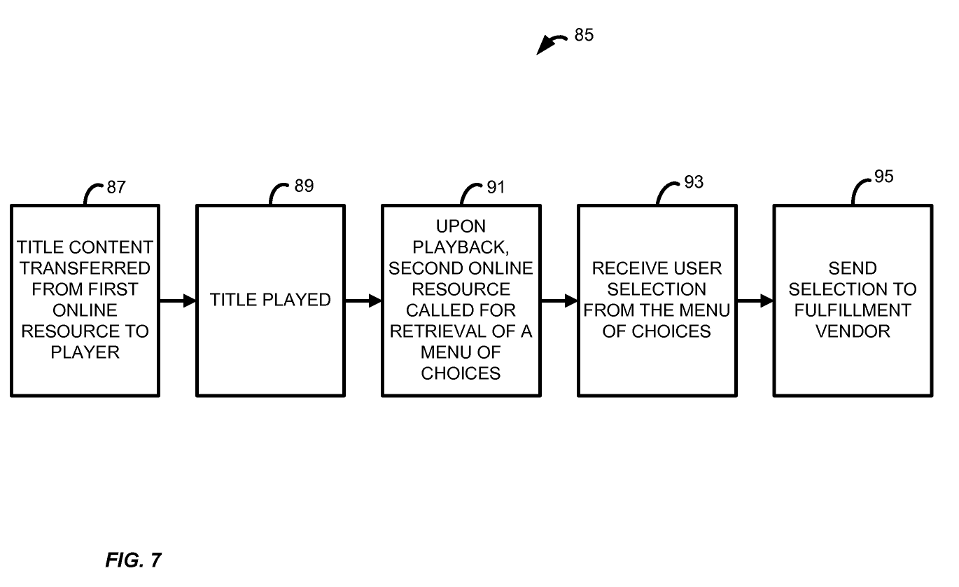

FIG. 7 is a flowchart 85 illustrating a fourth implementation of a method of the invention, this implementation where the title content and menu information have been retrieved from an online resource. A first step of this method is to transfer title content from a first online resource to a media player (step 87). The content is then played back (step 89). Upon the playback, a second online resource is called for retrieval of a menu of choices (step 91) and the same are displayed to the user. Of course, it will be understood that the first online resource may be the same as the second online resource. A next step is to receive a user selection from the menu of choices (step 93). A final step is to send information about the selection to a fulfillment vendor (step 95). Variations will be apparent given this teaching. For example, an intermediate network server may be employed, as may the BD-Live® system. Their employment may be in the same way as described above and the description is not repeated here.

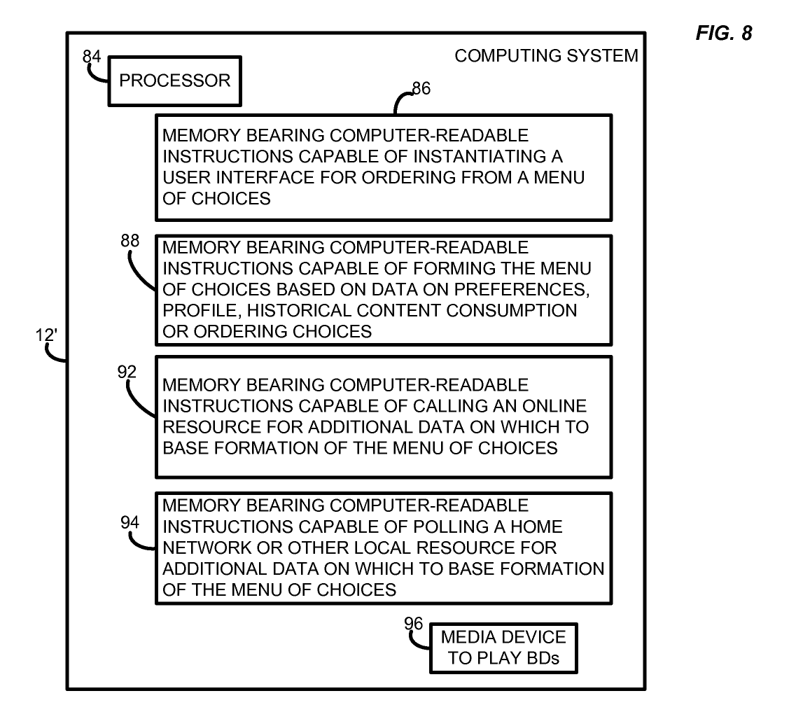

FIG. 8 illustrates a first exemplary structure of a computing system 12′ that may be employed to implement one or more of the features described herein. The computing system 12′ may correspond to, e.g., any of the disclosed media players. The computing system 12′ includes a processor 84 and a media device 96 on which may be played a computer-readable medium such as a BD. The computing system 12′ also includes memory 86 bearing computer-readable instructions capable of instantiating a user interface for ordering from a menu of choices. The computing system 12′ further includes memory 88 bearing computer-readable instructions capable of forming the menu of choices based on data on preferences, profiles, historical content consumption, historical ordering choices, content on the computer-readable medium, or the like. The computing system 12′ further includes memory 92 bearing computer-readable instructions capable of calling an online resource for additional data on which to base formation of the menu of choices. This additional data may include, e.g., additional user information available online or title—specific information, as well as other appropriate information. The computing system 12′ may also include memory 94 bearing computer-readable instructions capable of polling a home network or other local resource for additional data on which to base the formation of the menu of choices. Other memories may be employed to bear other pertinent information, instructions, and data.

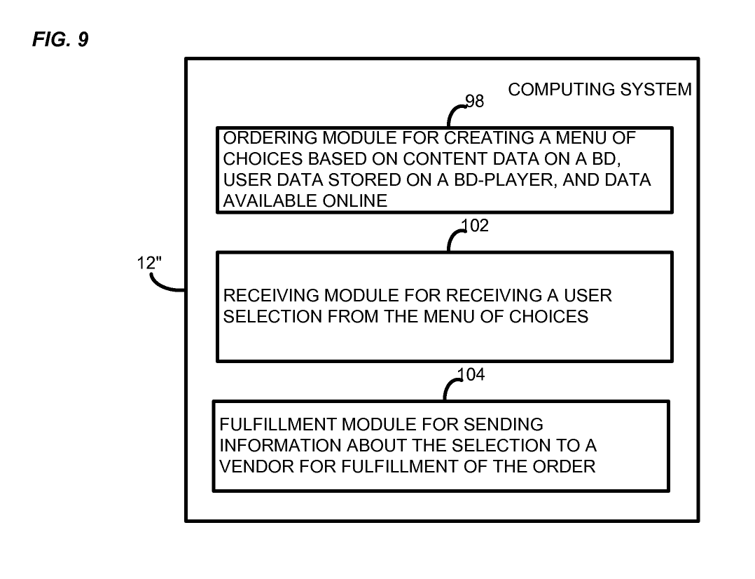

FIG. 9 illustrates a second exemplary structure of a computing system 12″ that may be employed to implement one or more of the features described herein. The computing system 12″ includes an ordering module 98 for creating a menu of choices based on content data on a computer-readable medium such as a BD. The ordering module 98 may further create the menu of choices based on user data stored on a media player as preferences or a profile. The ordering module 98 may further create the menu of choices based on other sources of data, e.g., online data, as disclosed above. The computing system 12″ further includes a receiving module 102 for receiving a user selection from the menu of choices. The computing system 12″ further includes a fulfillment module 104 for sending information about the selection to a vendor for fulfillment of the order.

Variations of the computing system 12″ will be apparent given this teaching. For example, a payment module may be included for requesting and receiving payment and authorization from a user for goods or services ordered and received. Moreover, not all of the modules need be located on a single system. In some cases, where the BD causes access to a web application, most or all of the modules may be on a non-local system.

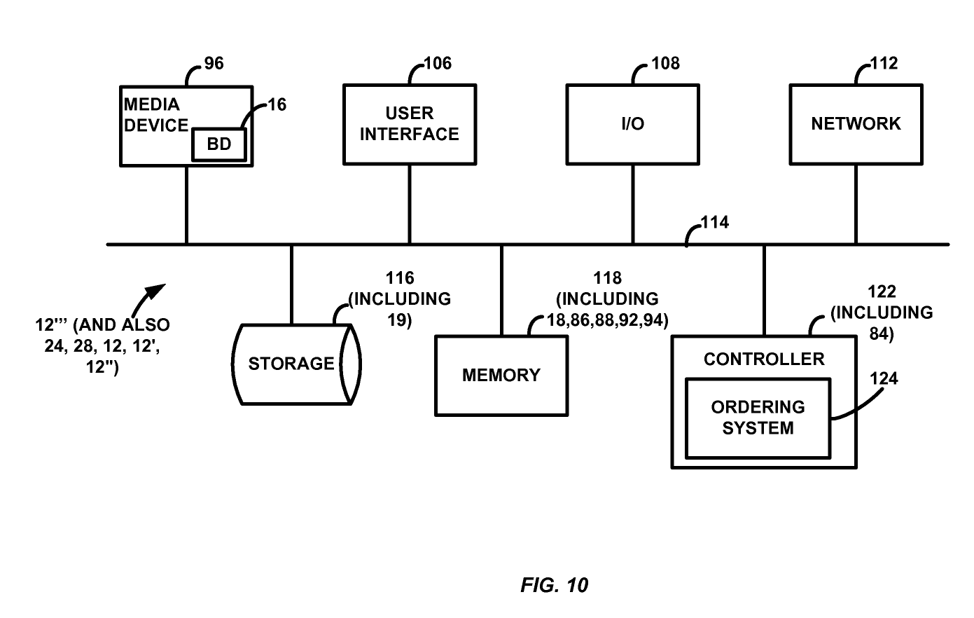

One implementation includes one or more programmable processors and corresponding computer system components to store and execute computer instructions, such as to provide the media player, and menu control and presentation. For example, referring to FIG. 10, a representation of an exemplary computing system 12′, which may correspond to a gaming console or the media player 12, 12′, 12″, or servers 24 or 28. The system 12′″ includes a memory 118, which may include memories 18, 86, 88, 92, 94, the storage area 116, which may include storage 19, the media device 96 for receiving a computer-readable medium, a user interface 106, an input/output (I/O) interface 108, and a network interface 112 for connection to the online resources. These components are interconnected by a common bus 114. Alternatively, different connection configurations can be used, such as a star pattern with the controller at the center.

A controller 122, which includes the processor 84 (FIG. 8), controls the operation of the system 12′″ and its components. The controller 122 loads instructions from the memory 118 or an embedded controller memory (not shown) and executes these instructions to control the system. In its execution, the controller 122 may provide the system for providing a menu of choices for ordering during playback as, in part, a software system. Alternatively, this service can be implemented as separate components in the system 12′″.

The memory 118 stores data temporarily for use by the other components of the system 12′″, such as for storing the ordering application during its execution. In one implementation, memory 118 is implemented as RAM. In some implementations, memory 118 also includes long-term or permanent memory, such as flash memory and/or ROM.

The storage area 116 stores data temporarily or long term for use by other components of the system 12′″, such as for storing data used by the system for creating the menu application. In one implementation, storage 116 is a hard disk drive. In another, storage 116 is a solid state drive or comprises flash memory or the like. Other storage devices will also be understood.

The media device 96 receives removable media and reads and/or writes data to the inserted media. In one implementation, the media device 116 is an optical disc drive or disk burner such as a Blu-ray® drive.

A user interface 106 includes components for accepting user input from the user of the system 12′″ and for presenting information to the user. In one implementation, the user interface 106 includes a keyboard, a mouse, audio speakers, and a display.

The I/O interface 108 includes one or more I/O ports to connect to corresponding I/O devices, such as external storage or supplemental devices, e.g., a printer or a PDA. In one implementation, the ports of the I/O interface 108 include ports such as: USB ports, PCMCIA ports, serial ports, and/or parallel ports. In another implementation, the I/O interface 108 includes an interface for wireless communication with external devices.

The network interface 112 includes a wired and/or wireless network connection, such as an RJ-45, or WiFi interface (802.11), or an Ethernet connection. Numerous other types of network connections will be understood to be possible, including WiMax, 3G or 4G, satellite, Bluetooth®, or the like. Any of these may be employed to connect to online resources 28.

The system 12′″ includes additional hardware and software typical of computing devices, e.g., power, cooling, operating system, though these components are not specifically shown in the figure for simplicity. In other implementations, different configurations of the device can be used, e.g., different bus or storage configurations or a multi-processor configuration.

While the arrangement has been described with respect to a computing device that is a media player or game console, it is to be understood that the arrangement may be implemented in any number of computing devices, including laptop computers, desktop computers, tablet computers, handheld computers, mobile phones, smart phones, and the like.

The examples above are illustrative and not limiting, and variations of the interactive system are possible as well. The system is not necessarily limited to BD, but could use other media such as DVD or the like. While certain user preference or profile information has been disclosed as suitable information on which to base a menu of choices, other information may also be employed. For example, the user may set specific fulfillment vendors as preferred vendors, or may provide a ranking or priority of vendors. While food ordering has been discussed, any types of goods and/services may be provided, including home repair services, music or movie downloads, and so on. While AACS DeviceAttribute and MediaAttribute have been described, the system and method may be employed in related contexts as well, including, e.g., the Digital Entertainment Content Ecosystem's Ultraviolet digital rights ecosystem. In this way, content association (MediaAttribute), device identification (AACS DeviceAttribute), and user identification may be employed to create a profile of user behavior, which may then be used to drive the selection of proposed goods or services. For example, the profile information collected and stored may be used to suggest particular food items and/or related content items that may be of interest to the user, given their past consumption history. While AACS DeviceAttribute and MediaAttribute have been described, the system and method may be employed in related contexts as well, including, e.g., the Digital Entertainment Content Ecosystem's Ultraviolet digital security format. In this way, content association (MediaAttribute), device identification (AACS DeviceAttribute), and user identification may be employed to create a profile of user behavior. Accordingly, the technology is not limited to the specific examples discussed above, which are provided only as example forms of implementing the claims.

1. A method of providing an ordering functionality using a non-transitory computer-readable medium in a media player, the non-transitory computer-readable medium for causing the media player to perform the following steps:
a. calculating and displaying a menu of choices, the menu pertaining to goods or services available to a user;
b. receiving a selection from a user from the menu of choices; and
c. sending the selection to a fulfillment vendor to provide the selected goods or services to the user.

2. The method of claim 1, wherein at least a portion of a set of instructions corresponding to the calculating and displaying, receiving, or sending steps are located on the computer-readable medium.

3. The method of claim 1, wherein at least a portion of a set of instructions corresponding to the calculating and displaying, receiving, or sending steps are located on the media player.

4. The method of claim 2, wherein at least a portion of a set of data employed in the calculating or sending steps are located in a storage in the media player.

5. The method of claim 4, wherein the portion of data employed in the calculating or sending steps are located in a user profile on the media player, in a set of user preferences on the media player, in a user history of content consumption on the media player, or in a user ordering history on the media player.

6. The method of claim 1, wherein at least a portion of a set of data employed in the calculating or sending steps are located on the computer-readable medium.

7. The method of claim 1, further comprising downloading at least a portion of a set of data employed in the calculating or sending steps from an online resource, wherein the downloading is caused by a call to the online resource caused by the computer-readable medium.

8. The method of claim 1, further comprising downloading at least a portion of a set of instructions corresponding to the calculating, receiving, or sending steps from an online resource, wherein the downloading is caused by a call to the online resource caused by the computer-readable medium.

9. The method of claim 7, wherein the call to the online resource is made through the BD-Live® system.

10. The method of claim 8, wherein the call to the online resource is made through the BD-Live® system.

11. The method of claim 1, further comprising a step of receiving payment information from the user for the selected good or service.

12. The method of claim 6, wherein the menu of choices is at least partially based on a content item on the computer-readable medium.

13. The method of claim 5, wherein the portion of data employed in the calculating or sending steps are chosen from at least two data selected from the group consisting of: a user profile on the media player, a user history of content consumption on the media player, a user ordering history on the media player, data downloaded from a network based on a call caused by the computer-readable medium, or a content item on the computer-readable medium.

14. The method of claim 1, wherein the sending includes sending the selection to a network server.

15. The method of claim 1, wherein if the goods are digital goods or services, further comprising downloading the digital goods or services corresponding to the selection from the fulfillment vendor to the user.

16. The method of claim 1, wherein the computer-readable medium is a Blu-ray® disc and the media player is a Blu-ray® player.

17. The method of claim 16, further comprising coupling the order with AACS DeviceAttribute to store user preferences.

18. The method of claim 16, further comprising coupling the order with MediaAttribute.

19. The method of claim 17, further comprising using the attribute to determine the fulfillment vendor.

20. The method of claim 18, further comprising using the attribute to determine the fulfillment vendor.

21. A computer-readable medium, comprising instructions for causing a computing system to perform the method of claim 1.

22. A method of providing an ordering functionality using a Blu-ray® title and a Blu-ray® player, the Blu-ray® title for causing the Blu-ray® player to perform the following steps:
a. transferring a Blu-ray® title from a first online resource to a Blu-ray® player;
b. running the Blu-ray® title;
c. upon the running, calling a second online resource for retrieval of a menu of choices, the menu pertaining to goods or services available to a user;
d. receiving a selection from a user from the menu of choices; and
e. sending the selection to a fulfillment vendor to provide the selected goods or services to the user.

23. A computer-readable medium, comprising instructions for causing a computing system to perform the method of claim 22.

24. A method of providing an ordering functionality using a Blu-ray® disc in a Blu-ray® player, the Blu-ray® disc for causing the Blu-ray® player to perform the following steps:
a. displaying a menu of choices using BD-Java, the menu pertaining to delivery food items available to a user, the menu of choices created using at least information stored on the Blu-ray® player and information retrieved from the BD-Live® network;
b. receiving a selection from a user from the menu of choices; and
c. sending the selection to a fulfillment vendor to provide the selected food items to the user.

25. A computer-readable medium, comprising instructions for causing a computing system to perform the method of claim 24.

26. A computing system, comprising:
a. memory bearing computer-readable instructions capable of instantiating a user interface for ordering from a menu of choices;
b. memory bearing computer-readable instructions capable of forming the menu of choices based on data on preferences, profile, historical content consumption, or historical ordering choices; and
c. memory bearing computer-readable instructions capable of calling an online resource for additional data on which to based formation of the menu of choices.

27. A computing system, comprising:
a. An ordering module for creating a menu of choices based on content data on a computer-readable medium, user data on a media player, or online data;
b. A receiving module for receiving a user selection from the menu of choices; and
c. A fulfillment module for sending information about the selection to a vendor for fulfillment of the order.
